(19) United States
(12) Patent Application Publication
(10) Pub. No.: US 2018/0157123 A1
(43) Pub. Date: Jun. 7, 2018

(54) LIQUID CRYSTAL DISPLAY DEVICE

(71) Applicants: Shenzhen China Star Optoelectronics Technology Co. Ltd., Shenzhen (CN); Wuhan China Star Optoelectronics Technology Co. Ltd., Wuhan (CN)

(72) Inventor: Yuheng LIANG, Shenzhen (CN)

(73) Assignees: Shenzhen China Star Optoelectronics Technology Co. Ltd., Shenzhen (CN); Wuhan China Star Optoelectronics Technology Co. Ltd., Wuhan (CN)

(21) Appl. No.: 14/897,832

(22) PCT Filed: Sep. 9, 2015
(86) PCT No.: PCT/CN2015/089265

§ 371 Date: Mar. 2, 2017

(30) Foreign Application Priority Data
Aug. 27, 2015 (CN) 201510534224.5

(51) Int. Cl. G02F 1/1335

(52) U.S. Cl. CPC G02F 1/133617; G02F 1/133528; G02F 2001/133562; G02F 2001/133531; G02F 2001/133565; G02F 1/133512

(57) ABSTRACT

Provided is a liquid crystal display device, comprising a liquid crystal display panel, which includes an upper substrate, an opposite lower substrate, and a liquid crystal layer disposed between the upper substrate and the lower substrate, wherein a lower polarizing layer is provided on a side of the lower substrate facing the liquid crystal layer, and a quantum-dot color film layer is provided between the lower polarizing layer and the lower substrate. The liquid crystal display device has a higher color gamut and contrast, enabling better picture display.

### CROSS-REFERENCE TO RELATED APPLICATIONS

The present application claims the priority of Chinese patent application CN 201510534224.5, entitled “Liquid crystal display device” and filed on Aug. 27, 2015, the entirety of which is incorporated herein by reference.

### TECHNICAL FIELD

The present disclosure relates to the field of liquid crystal display technologies, and in particular, to a liquid crystal display device.

### TECHNICAL BACKGROUND

Quantum dots (QDs) refer to semiconductor crystal particles with a diameter in the range from 1 to 100 nm. Since particle sizes of QDs are smaller or close to an exciton Bohr radius of a corresponding bulk material, a quantum confinement effect is generated. The energy level structure changes from a quasi-continuous structure of the bulk material to a discrete structure of the quantum dot, which results in special stimulated radiation properties of the QDs. QDs have the advantages of a controllable emission wavelength and a narrow half width. At present, QDs of different emission wavelengths are excited with blue light to replace a color filter used in a current liquid crystal display device. It is possible to improve a color gamut of the liquid crystal display device by eliminating defects from spectral distribution of light generated when a blue backlight source is used to excite yellow phosphor.

However, in an existing liquid crystal display device, when QDs are used to substitute the color filter, since incident light reaches the QDs through a polarizer, polarized light reaching the QDs, after being excited, no longer has an effect of linear polarization. That is, a polarization state of the incident light disappears. As a result, during an operation of the display device, a light valve action of liquid crystals and the polarizer disappears, leading to display failure of the display device. In addition, in the existing liquid crystal display device, color filters formed by the QDs are usually provided outside of the liquid crystal display device. Such an arrangement fails to consider contrast decrease and color shift of the liquid crystal display device caused by excitation of the QDs by external ambient light.

### SUMMARY OF THE INVENTION

In order to further improve contrast of a liquid crystal display device, and enable the liquid crystal display device to have a better display effect, the present disclosure provides a liquid crystal display device.

According to the present disclosure, the liquid crystal display device comprises a liquid crystal display panel, which includes an upper substrate, an opposite lower substrate, and a liquid crystal layer disposed between the upper substrate and the lower substrate, wherein a lower polarizing layer is provided on a side of the lower substrate facing the liquid crystal layer, and a quantum-dot color film layer is provided between the lower polarizing layer and the lower substrate.

In the present disclosure, the quantum-dot color film layer is arranged between the lower polarizing layer and the lower substrate, such that incident light emitted by a backlight can pass through the quantum-dot color film layer first before entering the liquid crystal layer through the lower polarizing layer. This arrangement causes the incident light to first excite the quantum-dot color film layer to form light of a corresponding color. The light of the corresponding color enters the lower polarizing layer to form polarized light of the corresponding color, and the polarized light passes through the liquid crystal layer to realize normal display of the liquid crystal display device. Compared with the prior art, the liquid crystal display device of the present disclosure overcomes the defect of disappearance of a polarizing state of the incident light, which, after being emitted by the backlight, first passes through the polarizing layer before exciting a color filter film. The quantum-dot color film layer is arranged, on the one hand, to improve color gamut and contrast of the liquid crystal display device, and on the other hand, to enable a better display effect of the liquid crystal display device.

In some embodiments, the quantum-dot color film layer comprises a red sub-pixel unit, a green sub-pixel unit, and a transparent unit that are sequentially arranged. The red sub-pixel unit and the green sub-pixel unit each comprise quantum dots which, in response to excitation of blue light, can emit corresponding red light and green light. The transparent unit is provided for the blue light to directly pass through. The quantum-dot color film layer can be arranged to realize, through a blue backlight, three-pixel display of the quantum-dot color film layer, i.e., display of red, green, and blue pixels.

In some embodiments, portions of the quantum-dot color film layer corresponding to the red sub-pixel unit and the green sub-pixel unit are covered with a blue filter layer. With this arrangement, it is possible to prevent the blue light, which is not used to excite the red sub-pixel unit and the green sub-pixel unit, from being filtered by the blue color filter layer. That is, only monochromatic light of a corresponding color passes through each of the red sub-pixel unit and the green sub-pixel unit, thereby improving the color gamut and contrast of the liquid crystal display device.

In some embodiments, the quantum-dot color film layer comprises a red sub-pixel unit, a green sub-pixel unit, and a blue sub-pixel unit that are sequentially arranged. The red sub-pixel unit, the green sub-pixel unit, and the blue sub-pixel unit each comprise quantum dots which, in response to excitation of ultraviolet light, can emit corresponding red light, green light, and blue light. This arrangement uses ultraviolet backlight to realize red, green, and blue three-pixel display of the quantum-dot color film layer. Since the respective sub-pixel units are each formed of the corresponding quantum dots, light-emission properties of the quantum-dot color film layer excited by the ultraviolet backlight are similar and more uniform, thereby realizing better screen display of the liquid crystal display device.

In some embodiments, a first black matrix is formed between adjacent units. The first black matrix is arranged to shield a control line in a control circuit layer, so as to prevent the control line from influencing screen display of the liquid crystal display device.

In some embodiments, a second black matrix is arranged on a side of the upper substrate facing the liquid crystal layer, the second black matrix at least being partially corresponding to the first black matrix. The second black matrix can be arranged to enhance the ability of the liquid crystal display device to resist external light disturbances, so as to significantly improve contrast of an image and render the color of a picture brighter.

In some embodiments, an upper polarizing layer is provided on a side of the upper substrate facing away from the liquid crystal layer. On the one hand, such an arrangement simplifies fixed assembling of the upper polarizing layer, and on the other hand, the upper polarizing layer can work together with the lower polarizing layer provided on the lower substrate, so that ambient light, after passing through the upper polarizing layer, the liquid crystal layer, and the lower polarizing layer in sequence, is prevented from reaching the quantum-dot color film layer by light valve action of the polarizing layers. This prevents problems such as chromaticity shift of the liquid crystal display device caused by excitation of the ambient light to the quantum-dot color film layer, thereby improving contrast of the liquid crystal display device and achieving a better display effect of the liquid crystal display device.

In some embodiments, a polarization direction of the upper polarizing layer and that of the lower polarizing layer are perpendicular or parallel to each other. A constant dark mode of the liquid crystal display device can be realized by the upper polarizing layer and the lower polarizing layer with perpendicular polarizing directions; and a constant bright mode of the liquid crystal display device can be realized by the upper polarizing layer and the lower polarizing layer with parallel polarizing directions.

In some embodiments, a control electrode layer is further disposed between the lower substrate and the quantum-dot color film layer. The control electrode layer provides a driving voltage to the liquid crystal display device, for controlling normal display of the liquid crystal display device.

In some embodiments, the liquid crystal display device further comprises a blue backlight or an ultraviolet backlight.

Compared with the prior art, the present disclosure has the following advantages.

At the outset, the present disclosure overcomes the defect that the polarization state of the incident light disappears since the incident light emitted by the backlight first passes through the polarizing layer before exciting the color filter film, thereby further improving contrast of the liquid crystal display device.

Moreover, according to the liquid crystal display device of the present disclosure, different three-pixel designs are performed on the quantum-dot color film layer, thereby improving the color gamut and the contrast of the liquid crystal display device.

In addition, in the present disclosure, the second black matrix can be arranged to enhance the ability of the liquid crystal display device to resist external light disturbances, so as to significantly improve contrast of an image and render the color of a picture brighter.

### BRIEF DESCRIPTION OF THE DRAWINGS

The present disclosure will be illustrated in detail hereinafter with reference to the embodiments and the drawings. In the drawings:

FIG. 1 schematically shows the structure of a liquid crystal display device according to a first embodiment of the present disclosure;

FIG. 2 schematically shows the structure of a liquid crystal display device according to a second embodiment of the present disclosure; and

FIG. 3 schematically shows the structure of a liquid crystal display device according to a third embodiment of the present disclosure.

In the drawings, the same components are indicated with the same reference signs. The figures are not drawn in accordance with an actual scale.

### DETAILED DESCRIPTION OF THE EMBODIMENTS

The present disclosure will be further illustrated hereinafter with reference to the drawings.

The details described herein are exemplary and are intended to only serve as illustrative discussion of embodiments of the present disclosure. They are present in order to provide the most useful and understandable explanation that is believed to be essential to the principles and concepts of the present disclosure. In this regard, no attempt has been made to introduce the structural details of the present disclosure beyond an extent necessary for a fundamental understanding of the present disclosure. Those skilled in the art will readily appreciate how several forms of the present disclosure may be implemented in practice by reference to the description and the accompanying drawings.

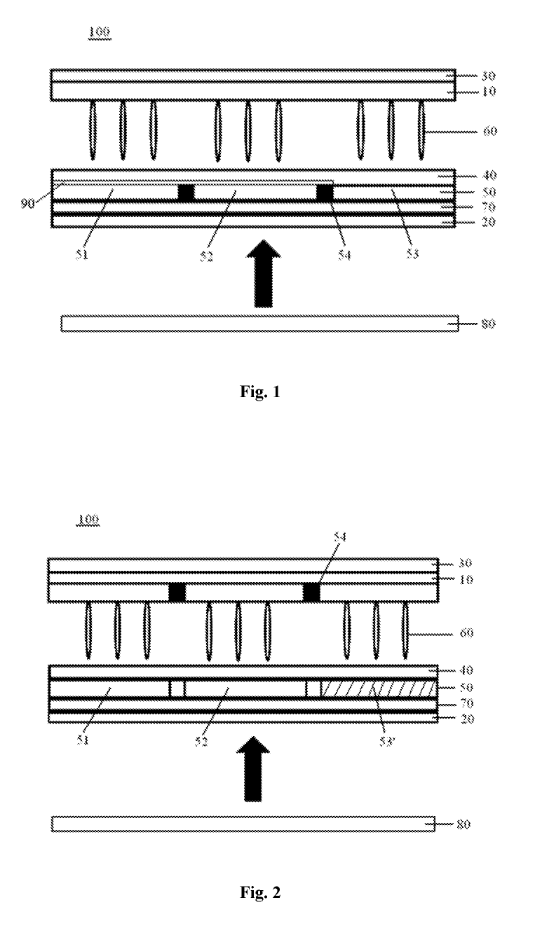

FIG. 1 schematically shows the structure of a liquid crystal display device 100 according to a first embodiment provided in the present disclosure. As shown in FIG. 1, the liquid crystal display device 100 comprises a liquid crystal display panel, which includes an upper substrate 10, an opposite lower substrate 20, and a liquid crystal layer 60 disposed between the upper substrate 10 and the lower substrate 20, wherein a lower polarizing layer 40 is arranged on a side of the lower substrate 20 facing the liquid crystal layer 60, and a quantum-dot color film layer 50 is disposed between the lower polarizing layer 40 and the lower substrate 20.

In the present disclosure, the quantum-dot color film layer 50 is disposed between the lower polarizing layer 40 and the lower substrate 20, such that incident light emitted by a backlight 80 first passes through the quantum-dot color film layer 50 before entering the liquid crystal layer 60 through the lower polarizing layer 40. Such an arrangement causes the incident light to first excite the quantum-dot color film layer 50 to form light of a corresponding color, and then the light of the corresponding color enters the lower polarizing layer 40 to form polarized light of the corresponding color. The polarized light passes through the liquid crystal layer 60 and the upper polarizing layer 30, to realize normal display of the liquid crystal display device 100. Compared with the prior art, the present disclosure overcomes the defect that the polarization state of the incident light disappears as the incident light emitted by the backlight first passes through a polarizing layer before exciting a color filter film. The quantum-dot color film layer 50 is used, on the one hand, to enhance color gamut and contrast of the liquid crystal display device 100, and on the other hand, to enable a better display effect of the liquid crystal display device 100.

According to the present disclosure, blue light or ultraviolet light can be used as the backlight 80. In the embodiment as shown in FIG. 1, the quantum-dot color film layer 50 comprises a red sub-pixel unit 51, a green sub-pixel unit 52, and a transparent unit 53 that are sequentially arranged, wherein the red sub-pixel unit 51 and the green sub-pixel unit 52 each include quantum dots capable of being excited by blue light to produce corresponding red light and green light, and the transparent unit 53 is directly used for the blue light to pass through. In this case, the blue light is used as the backlight 80, and the quantum-dot color film layer 50 can be arranged in such a manner to realize three-pixel display of the quantum-dot color film layer by the blue backlight, i.e., display of red, green, and blue pixels.

Preferably, portions of the quantum-dot color film layer 50 corresponding to the red sub-pixel unit 51 and the green sub-pixel unit 52 are covered with a blue color filter layer 90, respectively. With this arrangement, it is possible to prevent blue light, which is not used to excite the red sub-pixel unit 51 and the green sub-pixel unit 52, from being filtered by the blue color filter layer 90. That is, only monochromatic light of a corresponding color passes through each of the red sub-pixel unit 51 and the green sub-pixel unit 52, thereby improving color gamut and contrast of the liquid crystal display device 100.

According to the present disclosure, the embodiment as shown in FIG. 2 differs from the embodiment shown in FIG. 1 in that a blue sub-pixel unit 53′ is disposed at a position of the transparent unit 53, and that the red sub-pixel unit 51, the green sub-pixel unit 52, and the blue sub-pixel unit 53′ each include quantum dots capable of being excited by ultraviolet light to generate corresponding red, green, and blue light, respectively. In this solution, the backlight 80 uses ultraviolet light, which can realize red, green, and blue three-pixel display of the quantum-dot color film layer 50 by the ultraviolet backlight. Since the respective sub-pixel units are formed of the corresponding quantum dots, light-emission properties of the quantum-dot color film layer 50 excited by the ultraviolet backlight are similar and more uniform, thereby realizing better screen display of the liquid crystal display device 100.

Preferably, quantum-dot materials constituting the sub-pixel units of respective colors may be selected from Group II-VI or Group I-III-VI quantum-dot materials, more preferably being at least one selected from a group consisting of CdSe, CdS, CdTe, ZnS, ZnSe, CuInS, and ZnCuInS.

According to the present disclosure, as shown in FIG. 1, a first black matrix 54 is formed between adjacent sub-pixel units. The first black matrix 54 is arranged to shield a control line in a control electrode layer 70, so as to prevent the control line from influencing screen display of the liquid crystal display device 100. The control electrode layer 70 provides a driving voltage to the liquid crystal display device 100, for controlling normal display of the liquid crystal display device 100. It can be understood that the first black matrix 54 may be arranged in a plurality of ways, as long as the function thereof is ensured. For example, in the embodiment as shown in FIG. 2, the first black matrix 54 can also be disposed in an area between corresponding adjacent sub-pixel units of the upper substrate 10.

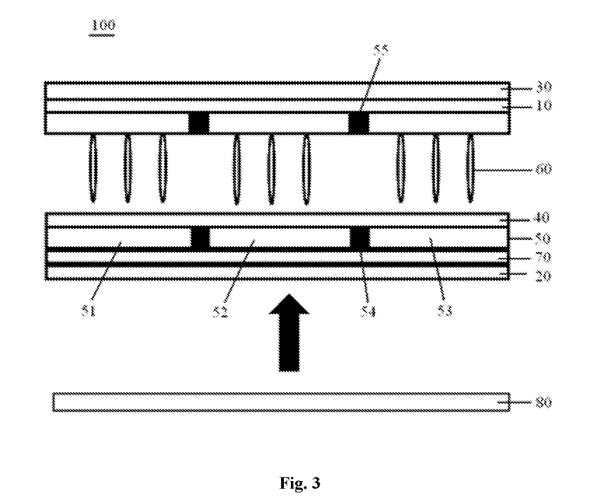

More preferably, in the embodiment as shown in FIG. 3, the upper substrate 10 is provided, on a side thereof facing the liquid crystal layer 60, with a second black matrix 55, which corresponds at least partially to the first black matrix 54. It is further preferred that, the second black matrix 55 corresponds entirely to the first black matrix 54. The second black matrix 55 can be arranged to enhance the ability of the liquid crystal display device to resist external light disturbances, so as to significantly improve contrast of an image and render the color of a picture brighter.

Back to FIG. 1, the upper polarizing layer 30 is disposed on a side of the upper substrate 10 facing away from the liquid crystal layer 60. On the one hand, such an arrangement simplifies fixed assembling of the upper polarizing layer 30, and on the other hand, the upper polarizing layer 30 can work together with the lower polarizing layer 40 provided on the lower substrate 20, so that ambient light, after passing through the upper polarizing layer 30, the liquid crystal layer 60, and the lower polarizing layer 40 in sequence, is prevented from reaching the quantum-dot color film layer 50 by light valve action of the polarizing layers. This prevents chromaticity shift of the liquid crystal display device 100 caused by excitation of the ambient light to the quantum-dot color film layer 50, thereby improving contrast of the liquid crystal display device 100 and achieving a better display effect of the liquid crystal display device 100.

According to the present disclosure, a polarizing direction of the upper polarizing layer 30 is perpendicular or parallel to that of the lower polarizing layer 40. A constant dark mode of the liquid crystal display device 100 can be realized by the upper polarizing layer 30 and the lower polarizing layer 40 with perpendicular polarizing directions; and a constant bright mode of the liquid crystal display device 100 can be realized by the upper polarizing layer 30 and the lower polarizing layer 40 with parallel polarizing directions.

It should be noted that the foregoing examples are for illustrative purposes only and are not to be construed as limitations of the present disclosure. While the present disclosure has been described in terms of exemplary embodiments, it is to be understood that a descriptive and illustrative language, rather than a limiting language is used herein. Within the scope of the presently recited and modified appended claims, the present disclosure may be varied without departing from the scope and spirit thereof. While the present disclosure has been described herein in terms of specific ways, materials, and embodiments, the present disclosure is not limited to the details disclosed herein, but rather, the present disclosure may be extended to, for example, structures, methods, and applications of all equivalent functions within the scope of the appended claims.

1. A liquid crystal display device, comprising a liquid crystal display panel, which includes an upper substrate, an opposite lower substrate, and a liquid crystal layer disposed between the upper substrate and the lower substrate, wherein a lower polarizing layer is provided on a side of the lower substrate facing the liquid crystal layer, and a quantum-dot color film layer is provided between the lower polarizing layer and the lower substrate.

2. The liquid crystal display device according to claim 1, wherein the quantum-dot color film layer comprises a red sub-pixel unit, a green sub-pixel unit, and a transparent unit that are sequentially arranged,
wherein the red sub-pixel unit and the green sub-pixel unit each comprise quantum dots which, in response to excitation of blue light, can emit corresponding red light and green light, and
wherein the transparent unit is provided for the blue light to directly pass through.

3. The liquid crystal display device according to claim 2, wherein portions of the quantum-dot color film layer corresponding to the red sub-pixel unit and the green sub-pixel unit are covered with a blue filter layer.

4. The liquid crystal display device according to claim 1, wherein the quantum-dot color film layer comprises a red sub-pixel unit, a green sub-pixel unit, and a blue sub-pixel unit that are sequentially arranged, and
wherein the red sub-pixel unit, the green sub-pixel unit, and the blue sub-pixel unit each comprise quantum dots which, in response to excitation of ultraviolet light, can emit corresponding red light, green light, and blue light.

5. The liquid crystal display device according to claim 2, wherein a first black matrix is formed between adjacent units.

6. The liquid crystal display device according to claim 5, wherein a second black matrix is arranged on a side of the upper substrate facing the liquid crystal layer, the second black matrix at least being partially corresponding to the first black matrix.

7. The liquid crystal display device according to claim 3, wherein a first black matrix is formed between adjacent units.

8. The liquid crystal display device according to claim 7, wherein a second black matrix is arranged on a side of the upper substrate facing the liquid crystal layer, the second black matrix at least being partially corresponding to the first black matrix.

9. The liquid crystal display device according to claim 4, wherein a first black matrix is formed between adjacent units.

10. The liquid crystal display device according to claim 9, wherein a second black matrix is arranged on a side of the upper substrate facing the liquid crystal layer, the second black matrix at least being partially corresponding to the first black matrix.

11. The liquid crystal display device according to claim 1, wherein an upper polarizing layer is provided on a side of the upper substrate facing away from the liquid crystal layer.

12. The liquid crystal display device according to claim 11, wherein a polarization direction of the upper polarizing layer and that of the lower polarizing layer are perpendicular or parallel to each other.

13. The liquid crystal display device according to claim 1, wherein a control electrode layer is further disposed between the lower substrate and the quantum-dot color film layer.

14. The liquid crystal display device according to claim 1, wherein the liquid crystal display device further comprises a blue backlight or an ultraviolet backlight.
